(19) United States
(12) Patent Application Publication
(10) Pub. No.: US 2012/0017714 A1
(43) Pub. Date: Jan. 26, 2012

(54) GRIP CONTROL AND GRIP CONTROL SYSTEM FOR CONTROLLING MACHINERY

(75) Inventor: Massimo RINALDI, Tulsa, OK (US)

(73) Assignee: WALVOIL FLUID POWER CORP., Tulsa, OK (US)

(21) Appl. No.: 12/842,429

(22) Filed: Jul. 23, 2010

(51) Int. Cl. G05G 9/047

(52) U.S. Cl. 74/471 R

(57) ABSTRACT

A self-centering hand-operated controller and control system including a self-centering hand-operated controller for operating a machine requiring at least one directional control input.

### BACKGROUND OF THE INVENTION

The instant invention is directed toward a control system and a hand-operated controller for a machine driven by at least one directional control input.

As a non-exclusive example of such a machine, FIG. 1 illustrates an aerial platform 10 (also known as a “cherry picker”) as an articulated crane 12 provided on a vehicle or truck 11 for positioning the crane 12 into the vicinity of the workspace where overhead work is to be performed. A terminal end of the crane 12 is provided with a mobile operator station 14.

The joints of the crane 12 are moved by a hydraulic system, as known in the art, wherein high-pressure liquid (a hydraulic fluid having non-compressible qualities, such as oil) is transmitted throughout the crane 12 from a reservoir 2 to hydraulic actuators 4 (e.g., hydraulic cylinders and motors) via hydraulic lines or hoses 6 by means of a pump 1. The movement of the crane is controlled by control valves which regulate pressure and flow of the fluid in the hydraulic lines 6.

Cranes such as the aerial platform 10 in FIG. 1 are typically provided with two sets of control valves. The first set of control valves are ground-based control valves 3 at the base of the crane 12 for articulation of the crane 12 from the ground. The second set of control valves are implemented as remote control valves 5 located in the operator station 14 for controlling articulation of the crane 12 remotely from the top of the crane 12. The remote control valves 5 are particularly convenient, as it allows the worker in the operator station 14 to control his position as he or she performs his or her work.

The controller for actuating the remote control valves 5 is typically embodied as a control assembly, diagrammatically illustrated in FIG. 2, and may include a hand-operated grip control 15. In the prior art, the remote control valves 5 would comprise control valves similar to the ground-based control valves 3, comprising a plurality of valves 18,19 located in and mobile with the operator station 14. The grip control may comprise a handle 16 that articulates as many as four valves 18 or more. The four valves 18 direct fluid pressure through the hydraulic hoses and tubes from the reservoir 2 to the hydraulic actuators 4 to accomplish movement of the various parts of the crane 12. In addition, the grip control may include a safety trigger 17 articulating a safety valve 19. The safety valve 19 typically would operates such that if the trigger 17 of the grip control 15 is not pressed, no fluid is allowed to the other cylinders 18 downstream so that no movement of the crane 12 takes place.

As embodied in the prior art, the grip control 15 enables precision movement of each of the different joints of the crane 12 with a single hand, leaving the worker's other hand free for other purposes. However, as known in the art, it is necessary to provide hydraulic hoses and tubes, in addition to those connecting to the hydraulic actuators 4, all the way up the crane to the second control valves 5 of the operator station 14 for each hydraulic actuator 4 to be controlled. These hydraulic hoses terminate in the valves 18, one for each hose for each actuator 4 to be controlled.

This design, however, has several disadvantages. The additional hydraulic hoses required to be run up the crane 12 to the control assembly 5 add weight, expense, and complexity to the crane, as well as requiring that pressurized fluid be maintained at the mobile operator site 14. The control assembly 5 further requires complex mechanics to facilitate precise changes to the fluid pressure in the hoses in response to the movements of the grip control 15, mechanics that also exist in the ground-based control valves 3 at the base of the crane 12.

There is therefore a need for a control system embodying the advantages of the grip control 15 for precise, one-handed operation of all the hydraulic operations of the crane 12 while reducing complexity, weight, and cost.

### SUMMARY OF THE INVENTION

The present invention is directed to solving the problems described above. The present invention comprises a hand-grip control configured for a plurality of different articulated movements, including a spring-loaded trigger for activating and deactivating the control, the control configured to actuate sensors responsive to each of the articulated movements.

According to a first aspect of the invention, the hand-grip control of the invention is a self-centering hand-operated control device for remotely controlling a hydraulic machine having at least three movable positioning elements, comprising an elongated handle with a coupling portion at one end and a gripping portion extending from the coupling portion along a longitudinal axis, the gripping portion being configured to be gripped by an operator's hand; a control assembly with a first end rotatably coupled to the coupling portion of the elongated handle such that the elongated handle is rotatable about the longitudinal axis, the control assembly extending along a first axis perpendicular to the longitudinal axis from the first end to a second end configured to be mounted to a surface, the control assembly including a plurality of sensors each configured to generate signals responsive to an operative movement of the elongated handle about any of the longitudinal axis, the first axis, and a second axis orthogonal to the longitudinal and first axes, and the control assembly also including centering mechanisms configured to resiliently maintain the elongated handle and the control assembly in a neutral position respective to the longitudinal axis, the first axis, and the second axis in the absence of an operative force upon the elongated handle.

According to a second aspect of the invention, there is provided a self-centering hand-operated control system for remotely controlling a hydraulic machine having at least three movable positioning elements, comprising a hand-operated control device as described above, a control interface configured to receive the generated signals from the control device and pilot a hydraulic valve device configured to operate hydraulic motors for positioning the movable positioning elements; and a transmission interface for transmitting the generated signals from the control device to the control interface.

In one embodiment of the invention, one or more of the first, second, and third sensors are potentiometers operable in response to the first, second, and third movements, respectively

In another embodiment of the invention, one or more of the first, second, and third sensors are each non-contacting rotary sensors using a Hall effect to measure relative angular displacement.

In yet another embodiment of the invention, the first, second, and third sensors are each optical devices configured to measure relative angular displacement.

In yet another embodiment of the invention, the elongated handle comprises a trigger lever extending along the longitudinal length of the elongated handle and configured to rotate about the longitudinal axis with the rotation of the elongated handle, the trigger lever configured to generate a trigger signal responsive to an operative squeezing of the trigger lever by the operator's hand.

In a further embodiment of the invention, the control assembly further comprises a parallelogram mechanism pivotally movable by a horizontal displacement along a horizontal direction of the elongated handle, the parallelogram mechanism including a fourth electronic sensor configured to generate a signal responsive to the horizontal displacement.

In a yet still another embodiment of the invention, the control interface is further configured to override the first, second, and third signals received respectively from the first, second, and third electronic sensors upon receiving the trigger signal.

In a yet further embodiment of the invention, each of the centering mechanisms are configured to limit an angular displacement to a maximum angular displacement.

In yet another further embodiment of the invention, each centering mechanism comprises first and second commonly pivoted spring-arms each having a middle portion, a distal end, a proximal end opposite the distal end, and a lateral extension, each of the proximal end, the distal end, and the lateral extension extending from the middle portion, the first and second spring-arms configured to rotate with respect to each other about a common axis through the respective middle portions, the middle portions of the spring-arms having openings for receiving a pivot shaft, the distal ends of the spring-arms being connected to each other by a tension device configured to urge the distal ends toward each other, and the lateral extensions of the spring-arms having stop portions configured to limit a rotational motion of said spring-arms about the common axis to the maximum angular displacement.

In yet another still further embodiment of the invention, the stop portions of each spring-arm is configured to abut against a corresponding abutment portion of the opposite spring-arm.

In still yet another further amendment of the invention, the elongated handle is coupled to a first section of the control assembly, the first second including the plurality of sensors and the centering mechanisms, the first section is pivotably mounted to a second section of the control assembly, the second section including the parallelogram mechanism, the first section configured to pivot about the first axis relative to the second section, a first of the plurality of sensors being configured to indicate an operative force to pivot the first section about the second section, the elongated handle comprises a first pivot shaft extending along the longitudinal axis, the first pivot shaft configured to rotate with a first operative motion about the longitudinal axis and further configured to engage with a second of the plurality of sensors located at an end of the first pivot shaft, an outer peripheral surface around a circumference of the first pivot shaft at an end of the first pivot shaft having a cavity extending into the surface of the first pivot shaft, the end of the first pivot shaft extending through an opening in a first leaf spring housing, the first leaf spring housing including a first leaf spring having an first engagement portion in engagement with the outer peripheral surface of the first pivot shaft and configured to reversibly enter the first cavity of the first pivot shaft to prevent a rotation of the first pivot shaft about the longitudinal axis where a torque applied to the first pivot shaft is less than a first predetermined value greater than zero, and one of the arms of the parallelogram mechanism is connected to a second pivot shaft configured to rotate responsive to a horizontal displacement of the horizontal body, the second pivot shaft configured to engage with the displacement sensor, an outer peripheral surface around a circumference of the second pivot shaft at an end of the second pivot shaft having a cavity extending into the surface of the second pivot shaft, the end of the second pivot shaft extending through an opening in a second leaf spring housing, the second leaf spring housing including a second leaf spring having a second engagement portion in engagement with the outer peripheral surface of the second pivot shaft and configured to reversibly enter the second cavity of the first pivot shaft to prevent a rotation of the second pivot shaft about an axis through a center of the second pivot shaft where a torque applied about axis through a center of the second pivot shaft is less than a predetermined value greater than zero.

These and other embodiments and advantages of the present invention may become apparent from the following detailed description, taken in conjunction with the accompanying drawings, illustrating by way of example the principles of the invention.

### BRIEF DESCRIPTION OF THE DRAWINGS

FIG. 1 diagrammatically illustrates an exemplary embodiment of a truck-based aerial platform including a crane and a mobile operator station with an exemplary control system in the prior art.

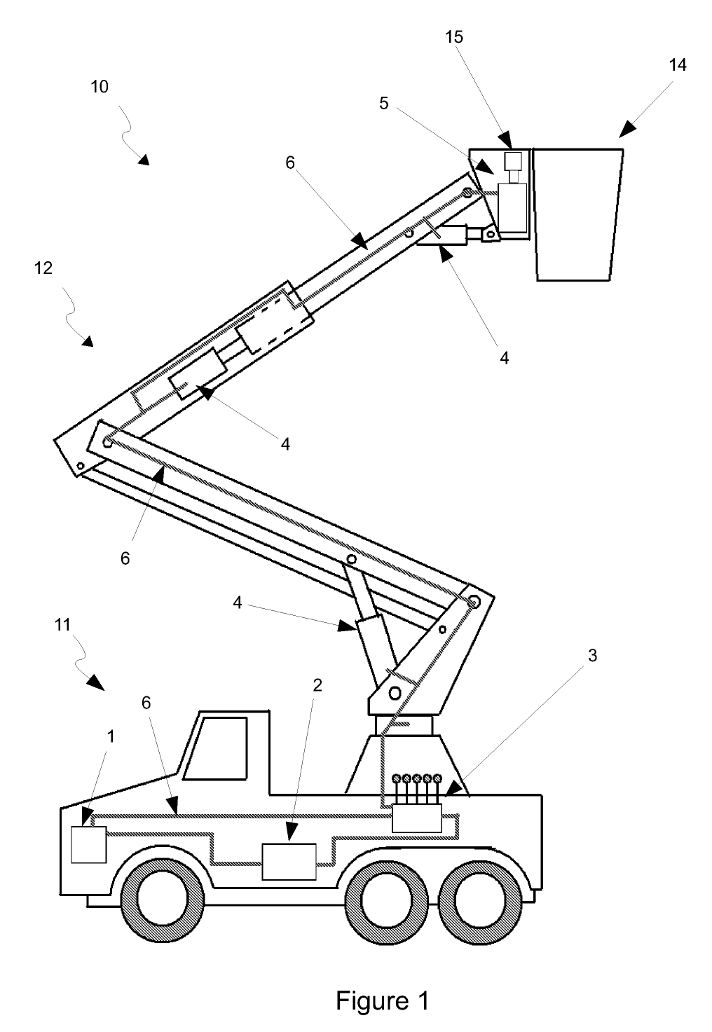

FIG. 2 diagrammatically illustrates an exemplary embodiment of a hand-grip control as known in the art for actuating the position of the aerial platform of FIG. 1.

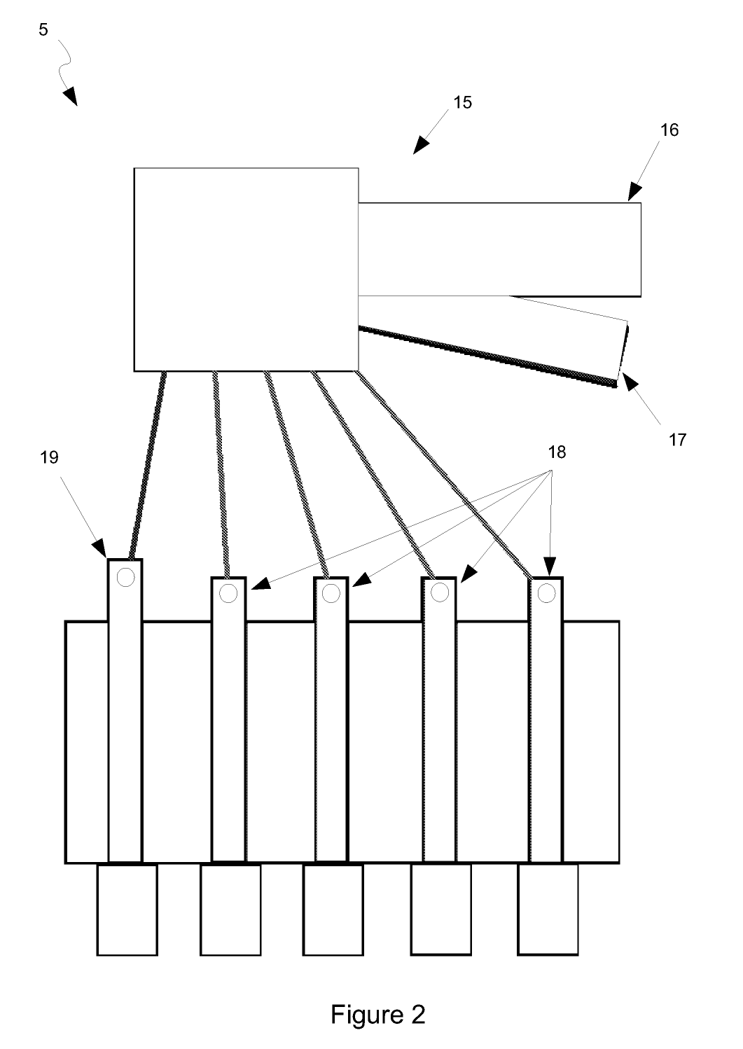

FIG. 3 diagrammatically illustrates an exemplary embodiment of a truck-based aerial platform including a crane and a mobile operator station with a control system in accordance with the invention.

FIG. 4 provides a perspective view of a hand-operated control device in accordance with the invention.

FIG. 5 provides a detail of FIG. 3 illustrating a spring-arm centering assembly in accordance with the invention.

FIG. 6 provides a diagrammatic top view of the spring-arm centering assembly in accordance with the invention.

FIG. 7 provides an exploded view of the spring-arm centering assembly in accordance with the invention.

FIG. 8 provides a perspective view of a leaf spring centering assembly in accordance with the invention.

FIG. 9 provides an exploded view of an elongated handle of the of the control device, including the spring-arm assembly and the leaf spring assembly associated with the handle for centering the handle.

FIGS. 10a and 10b illustrate a detail of the elongated handle from a rear of the control device and a detail from a front exterior of the elongated handle, respectively, the elongated handle being in a neutral position.

FIGS. 11a and 11b illustrate the detail of the rear and a front exterior, respectively corresponding to FIGS. 10a and 10b, wherein the elongated handle is in a biased position.

FIG. 12 is an exploded view of a base portion of the control assembly, including the spring-arm assembly and the leaf spring assembly associated with the handle for centering the base portion.

FIG. 13 is a similar view of FIG. 12 from another perspective.

FIGS. 14a and 14b provide opposing side views of the assembly of FIGS. 12 and 13 in a neutral position.

FIGS. 15a and 15b correspond to FIGS. 14a and 14b wherein the assembly of FIGS. 12 and 13 are in a biased position.

FIG. 16 is an exploded view of an assembly of another part of the grip controller.

FIGS. 17a and 17b show top and bottom views, respectively, of the assembly of FIG. 16 in a neutral position.

FIGS. 18a and 18b correspond to FIGS. 17a and 17b wherein the assembly of FIG. 16 are in a biased position.

FIG. 19 is an exploded view of the parallelogram assembly of the grip controller.

FIGS. 20a and 20b show opposing side views of the parallelogram assembly of FIG. 19.

FIGS. 21a and 21b correspond to FIGS. 20a and 20b wherein the parallelogram assembly of FIG. 19 are in a biased position.

### DETAILED DESCRIPTION OF PREFERRED EMBODIMENTS

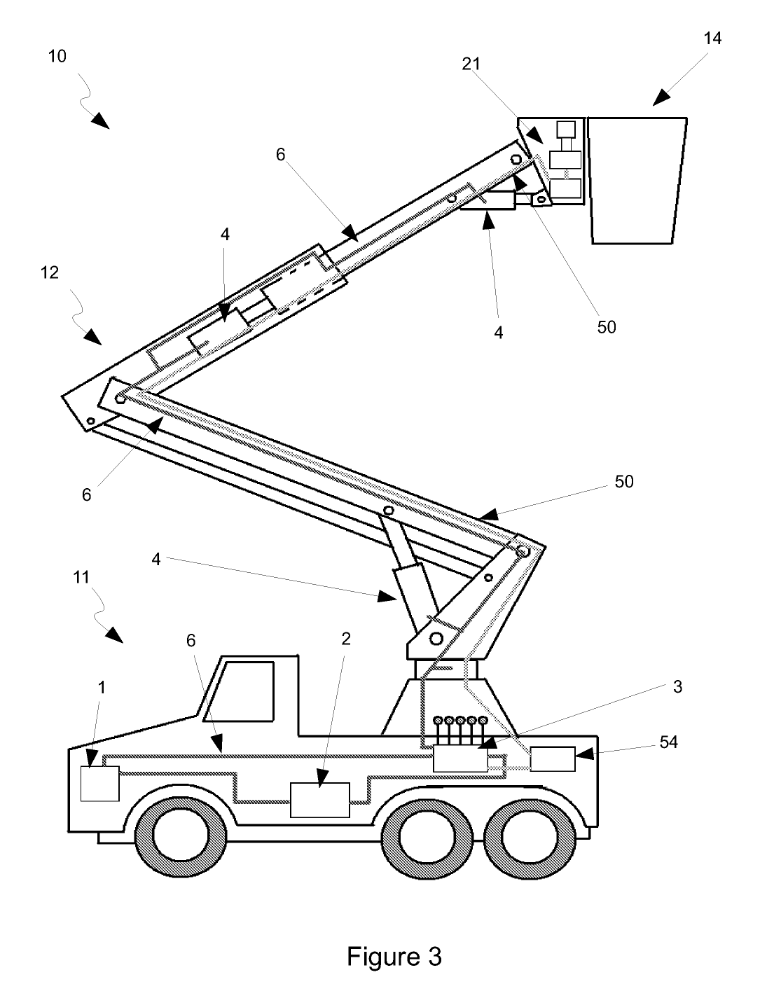

FIG. 3 shows an exemplary machine 10 controlled by directional inputs that is improved by the invention. The exemplary machine 10 includes a crane 12 positioned on a vehicle or truck 11. The truck 11 is used for positioning the crane 12 into the vicinity of the workspace where overhead work is to be performed.

In FIG. 3, the crane 12 is hydraulically actuated. Hydraulic motors or actuators 4 are located on the crane 12 as known in the art for elevating and positioning the crane 12.

In accordance with the invention, a grip controller 21 in the operator station 14 remotely controls the hydraulic actuators 4 from the position of the operator station 14, thereby enabling the operator to precisely position the operator station 14 to where overhead work is to be performed. The grip controller 21 is connected via a transmission interface 50 to a control interface 54 configured to receive signals from the grip controller 21. The transmission interface 50 connecting the grip controller 21 and the control interface 54 may be electric lines (e.g., electric cabling), optical lines (e.g., fiber-optic cabling) or other means of signal transport.

In an embodiment of the invention, the control interface 54 includes a computer device having at least a CPU, a random-access memory, a first signal interface for receiving and translating signals from the grip controller 21 into data readable by the CPU, a second signal interface for transmitting signals to the control valves 3, and a non-volatile storage memory storing a program for configured to cause the CPU to translate signals received from the grip controller 21 into corresponding signals to the control valves 3 so that operation of the grip controller 21 will cause the hydraulic actuators 4 of the crane 12 to move in a known, predictable, and reliable manner.

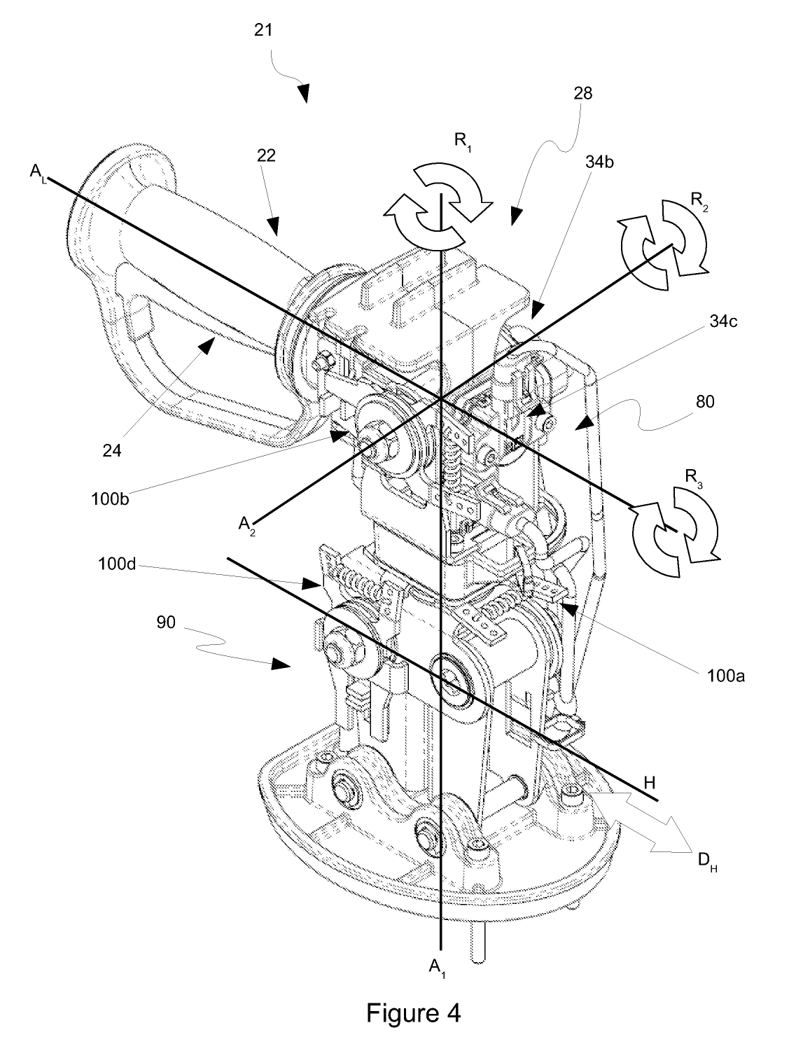

One embodiment of the inventive grip controller 21 is shown in FIG. 4. The grip controller 21 includes an elongated handle 22 configured to be gripped by an operator's hand, one end rotatably connected to an upper housing 80 of a control assembly 28 along a longitudinal axis A_{L}.

The elongated handle 22 is connected to a sensor 34c configured to generate a signal corresponding to a rotational movement R₃ and/or angular position of the handle 22, caused by an operative twisting motion of the handle 22 about the longitudinal axis A_{L}. The grip controller is further configured to enable and sense rotational motions R₁ and R₂ about respective axes A₁ and A₂, as will be described later.

The upper housing 80 is mounted upon a parallelogram mechanism 90. The parallelogram mechanism 90 includes two arms configured to extend in substantially a direction of a first axis A₁ perpendicular to the longitudinal axis A_{L}. The parallelogram mechanism 90 is mounted on a base such that the parallelogram mechanism 90 does not rotate about the first axis A₁, and the upper housing 80 is rotatably mounted on the parallelogram mechanism so that it can rotate about the first axis A₁ responsive to an operative side-to-side motion of the handle 22.

The upper housing 80 also includes a pivot mechanism so that the upper housing 80 may pivot about a second axis A₂ in response to an operative up or down motion of the handle 22.

The handle 22 also includes in an embodiment of the invention a squeeze trigger 24 extending along a longitudinal length of the elongated handle 22. The squeeze trigger 24 rotates about the longitudinal axis A_{L} with the rotation of the elongated handle 22, and the squeeze trigger 24 is connected to a switch (not shown) configured to generate a trigger signal responsive to an operative squeezing of the squeeze trigger 24 by the operator gripping the handle 22. This squeeze trigger 24 is intended as a safety mechanism, and sends a signal to the control interface 54 to immediately override any other control input and stop all motion of the crane 12.

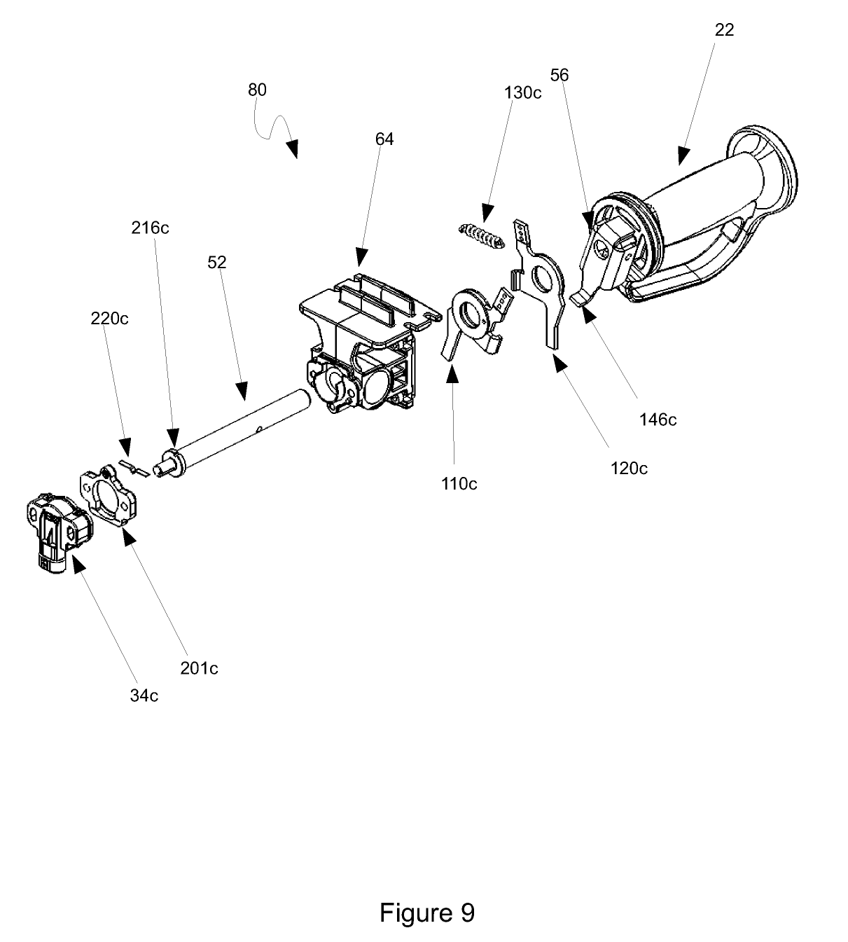

The upper housing 80 of the control assembly 28, as shown in FIG. 4 and further detailed in FIGS. 9-18, is configured for movement about the longitudinal, first, and second axes A_{L}, A₁, A₂ in response to three operative rotational movements R₃, R₁, R₂ about the respective axes. Each rotational movement generates a corresponding signal from one of three sensors 34a, 34b, 34c. In addition, the parallelogram mechanism 90 control assembly 28 allows a fourth movement in a horizontal direction H responsive to an operative horizontal displacement D_{H} of the handle 22 and the upper housing 80. The horizontal displacement D_{H} is measured by a displacement sensor 34d.

Signals from each of the sensors 34a, 34b, 34c and 34d are transmitted to the control interface 54 in order to control the movements of the hydraulic actuators 4. As a result, the operative movements of the grip controller 21 operate the crane 12.

It is most important that a neutral position of the grip controller 21 be established between the grip controller 21 and the control interface 54. The neutral position is a position of the grip controller 21 when no operative force is applied by an operator, whereupon to the corresponding signals from the sensors 34a, 34b, 34c and 34d causes the control interface 54 to maintain the crane 12 in a still position.

Accordingly, the embodiment of the invention includes mechanisms to maintain the grip controller 21 in the neutral position, such that each of the sensors 34a, 34b, 34c and 34d are maintained in corresponding neutral positions. In the embodiment, each of the movements R₃, R₁, R₂, D_{H} are regulated by a centering mechanism incorporating a spring-arm mechanism 100 and a leaf spring assembly 200.

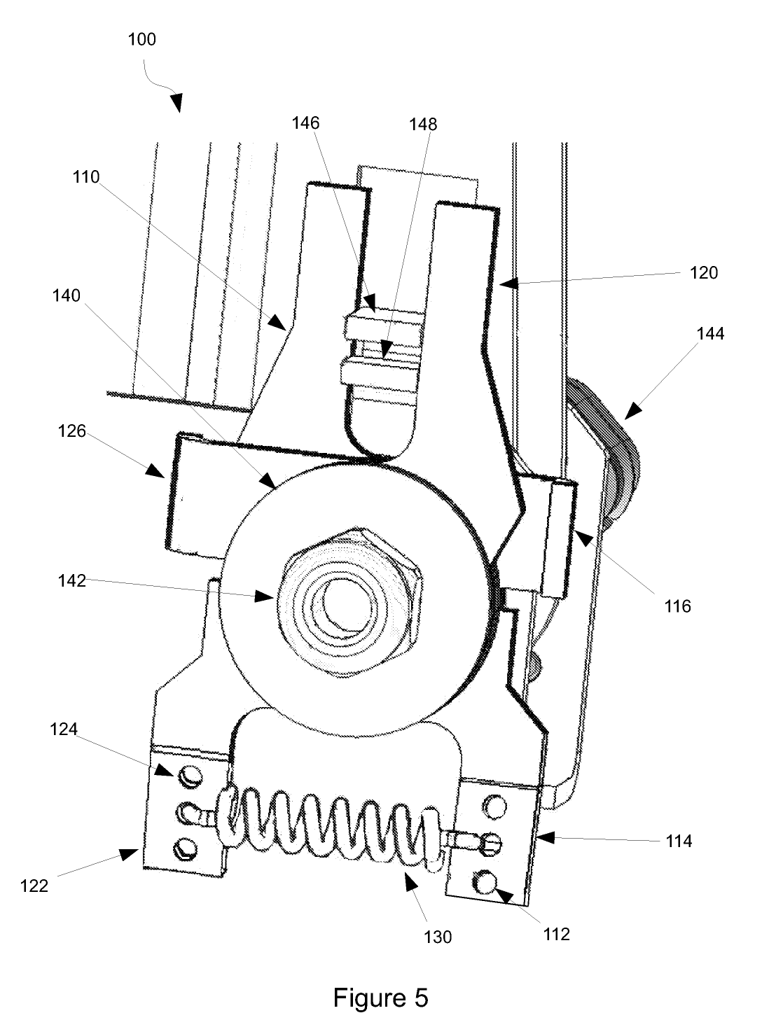

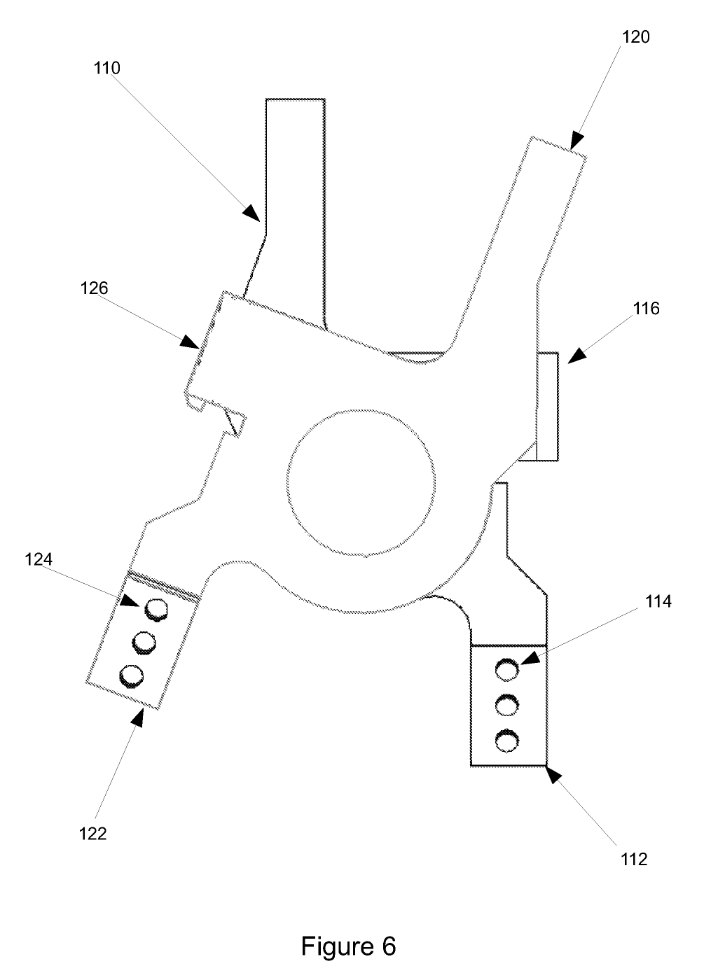

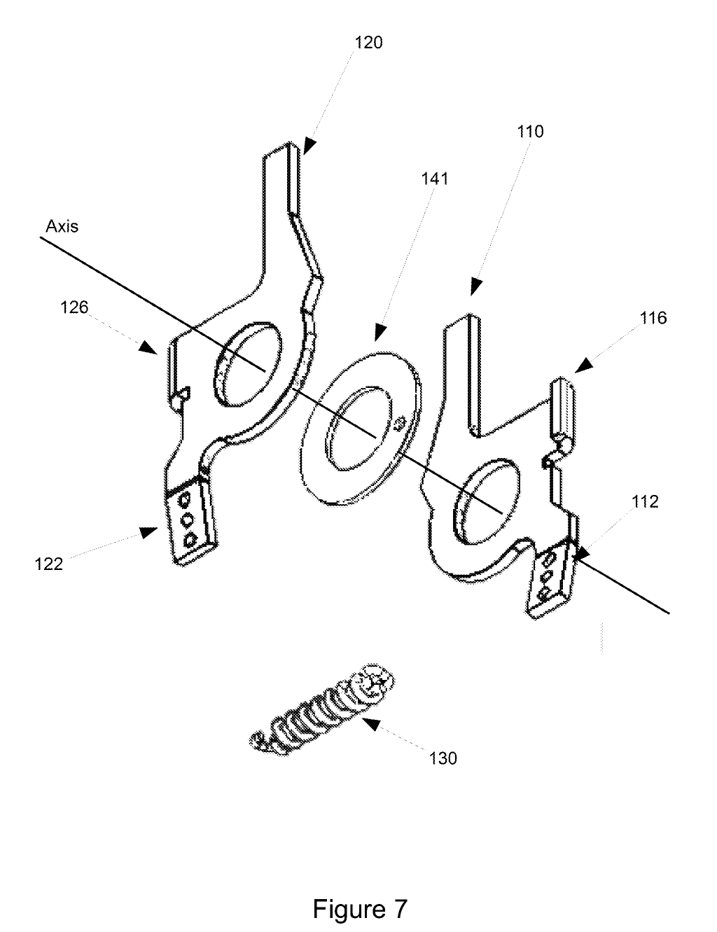

In FIGS. 5-7, a spring-arm mechanism 100 is shown. A first pivot arm 110 and a second pivot arm 120 are assembled together to pivot about a common axis through a middle of each pivot arm. Each pivot arm also has a distal end 112, 122, each provided with holes 114, 124 wherein a spring 130 is attached. Each pivot arm is yet further provided with a lateral extension 116, 126 extending in a direction substantially parallel to an axis from the pivot arms to the distal ends 112, 122, the lateral extensions 116, 126 each having protrusions that will stop a rotational motion of the pivot arms at a predetermined rotational displacement. The maximum rotational displacement corresponds to a length of the lateral extensions 116, 126. The pivot arms in FIG. 5-7 are secured together upon a common shaft by a washer 140 and a nut 142, and a rotational motion of the pivot arms 110, 120 with respect to each other may be facilitated by an intermediate washer 141 provided between the pivot arms 110, 120.

The spring-arm mechanism 100 is actuated by lateral tabs 146, 148 which are provided on the grip controller 21 for each of the movements R₃, R₁, R₂, D_{H}. In an operative motion of the grip controller about one of the operative axes, one the lateral tabs 146, 148 will move with the operative motion while the other of the lateral tabs 146, 148 will remain in place. As shown in FIG. 5, both lateral tabs 146, 148 are in the neutral position wherein the tabs are above and below each other. The lateral tabs 146, 148 are above and below each other such that the spring-arms 110, 120 are closest to each other and the spring 130 is in a state of least tension.

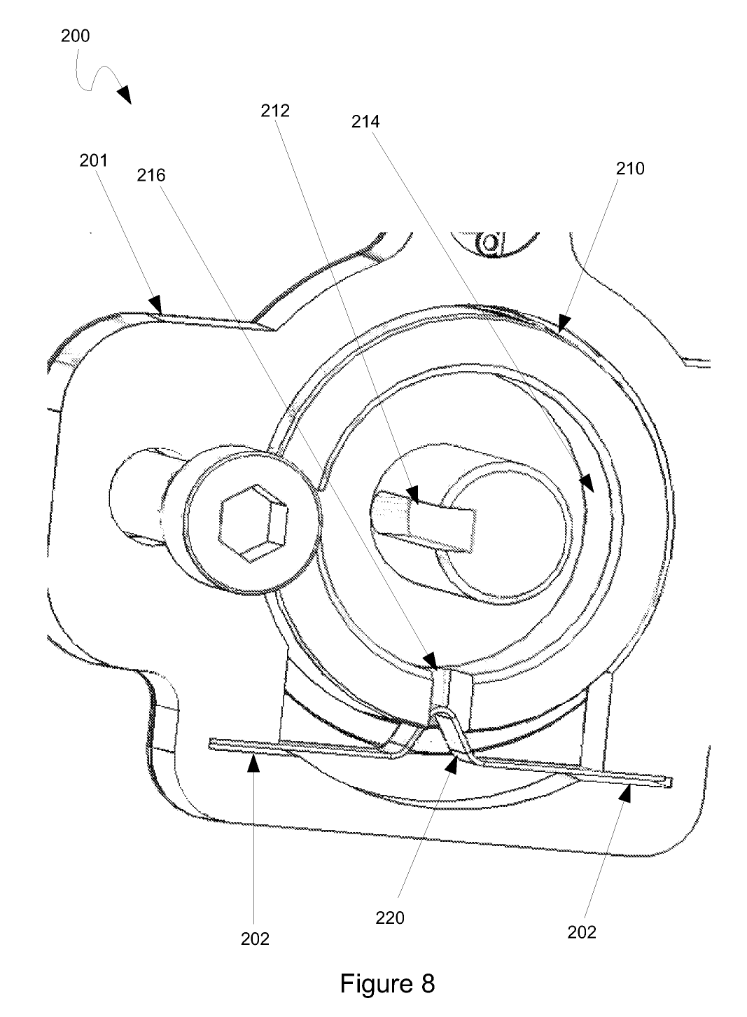

The neutral position is further maintained by a leaf spring assembly 200 as shown in FIG. 8. In the embodiment, each of the movements R₃, R₁, R₂, D_{H} rotates a corresponding shaft 210, an outer peripheral surface of each shaft having a cavity 216 extending into the surface of the shaft. The shaft 210 is mounted through a leaf spring housing 201 which includes slots 202 for receiving and securing a leaf spring 220. The leaf spring 220 extends in a longitudinal direction with a V-shaped bend extending transversely to the longitudinal direction of the leaf spring 220, the V-shaped bend configured to fit within the cavity 216 on the circumferential periphery of the shaft.

In the embodiment, a key 212 is presented by the shaft to interface with a rotatable part of a sensor.

When in the neutral position, the leaf spring 220 is urged into the cavity 216 of the shaft via residual tension in the spring. The V-shaped bend maintains the shaft in the neutral position until an operative torque is applied to turn the shaft within the leaf spring housing 201 is forceful enough to overcome the tension in the spring and cause the V-shaped bend to exit the cavity 216. The tension of the leaf spring 220 will then maintain the V-shaped bend of the leaf spring 220 in contact with the circumferential surface of the shaft until the cavity 216 of the shaft is again brought into contact with the V-shaped bend.

The centering mechanism operates as follows. The shaft 210 is urged by the spring-arms 110, 120 such that the leaf spring 220 is brought into proximity of the cavity 216. In an embodiment of the invention, spring-arms 110a-d, 120a-d are provided at each of the sensors 34a, 34b, 34c and 34d urge the grip controller 21 into neutral positions corresponding to each of the movements R₃, R₁, R₂, D_{H}, whereupon corresponding leaf spring assemblies 200a, 200b, 200c, 200d hold the grip controller in the neutral positions until a sufficient operative force is applied. The grip controller 21 in thus maintained in the neutral position with a high reliability.

By way of example, FIGS. 9-21 illustrate an embodiment of the invention incorporating the spring-arm mechanisms 100 and the leaf spring assembly 200 for the respective movements of the grip controller 21.

FIG. 9 shows an exploded view of an assembly of the handle 22 as it connects with the upper housing 80 of the grip controller 21. One end of the handle 22 comprises a coupling portion 56 fixedly connected to the handle so that a lateral tab 146c rotates with a rotation of the handle 22. The coupling portion 56 attaches to a first end of shaft 52. The shaft 52 passes through an upper rotatable part 64, and a second end of the shaft 52 has a cavity 216c configured to cooperate with the V-shaped bend of a leaf spring 220c. The shaft extends through leaf spring housing 201c to engage with leaf spring 220c and further to connect with sensor 34c. A spring-arm mechanism, comprising pivot arms 110c and 120c connected by spring 130c, is provided between the upper rotatable part 64 and the coupling portion 56, the lateral tab 146c fitting in between the pivot arms 110c, 120c.

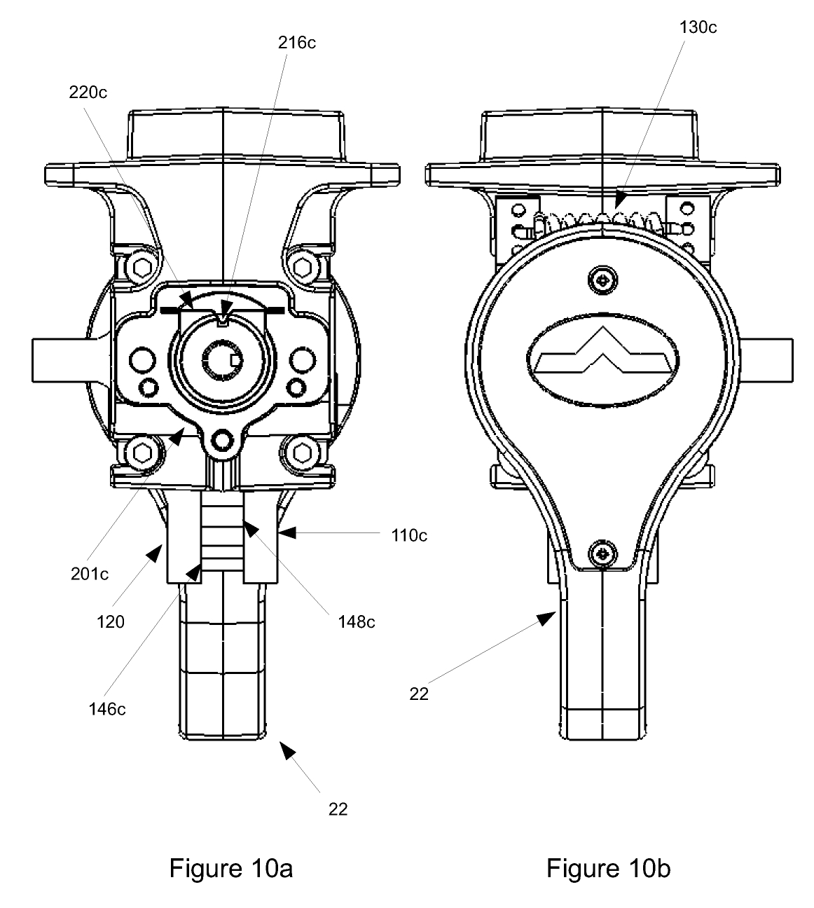

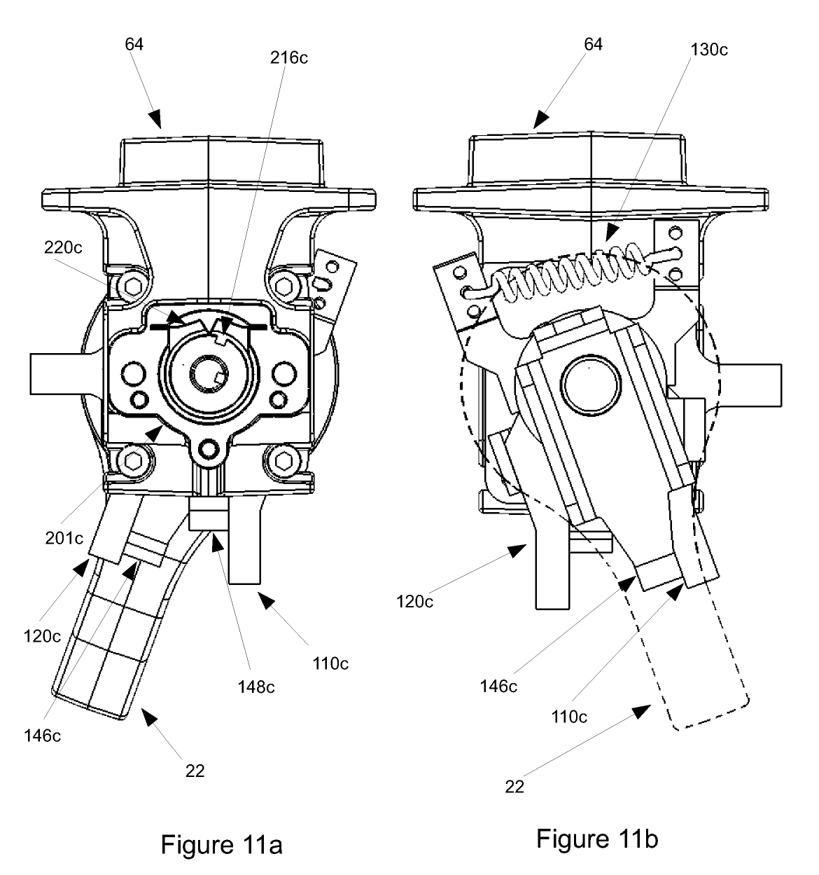

FIGS. 10a and 10b show a rear view and a frontal view, respectively, of the upper housing 80 of the control assembly wherein the handle 22 is in the neutral position. FIGS. 11a and 11b show respective bottom and top views of the upper housing 80 wherein the handle 22 is in a biased position. In FIGS. 10b and 11b, the sensor 34c is not shown to reveal the leaf spring housing 201c, leaf spring 220c, and cavity 216c.

In FIGS. 9, 10a-b, and 11a-b, lateral tab 146c is fixed to coupling portion 56 to move with the coupling portion 56. Lateral tab 148c is fixed to the upper rotatable part 64.

In FIGS. 11a and 11b, an operative movement R₃ of the grip controller 21 about the axis A_{L} causes the lateral tab 146c to force the spring-arm 120c away from the spring-arm 110c that is held in place by lateral tab 148c, increasing the tension in spring 130c and forcing the V-shaped bend of the leaf spring 220c from the cavity 216c. When the operative force is released, the tension in the spring 130c urges the spring-arms 110c and 120c together, bringing the lateral tabs 146c, 148c together and the handle 22 into the neutral position, whereupon the V-shaped bend of the leaf spring 220c enters the cavity 216c.

The other movements R₁, R₂, D_{H} of the grip controller 21 are regulated in a similar manner.

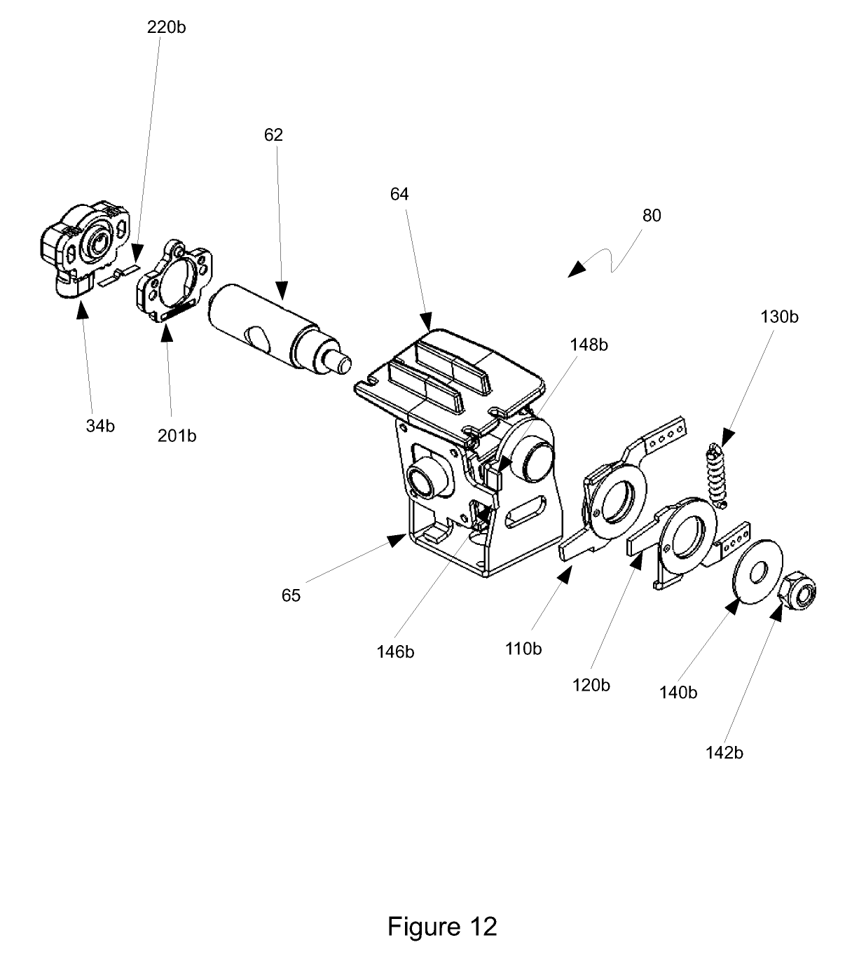

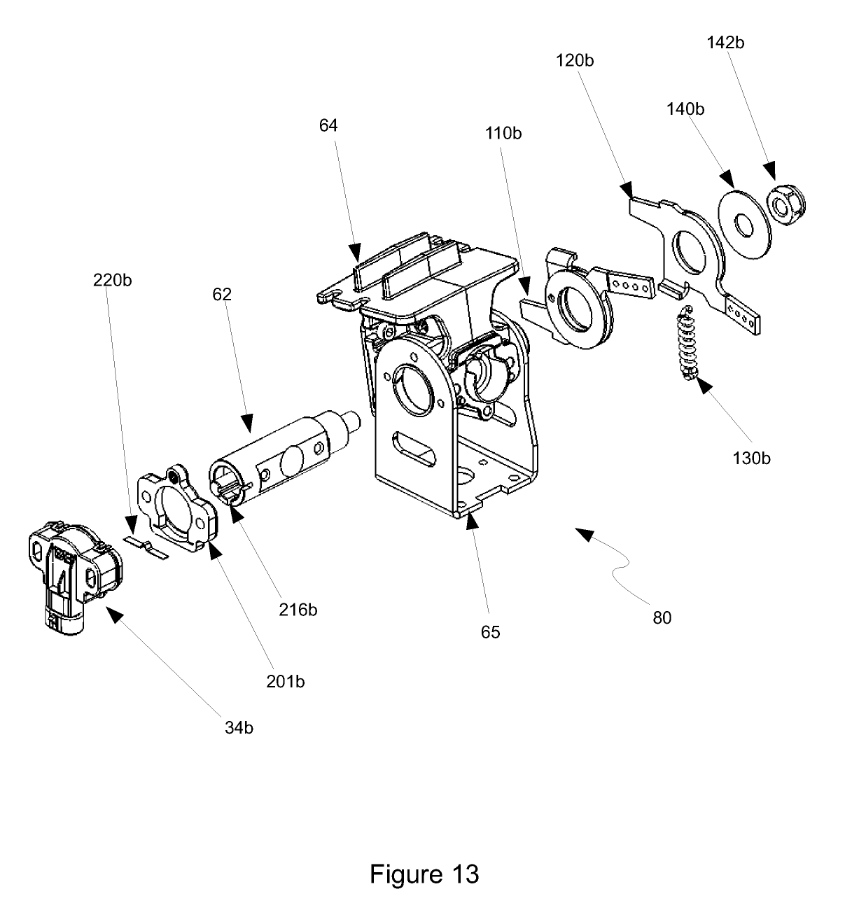

For example, FIGS. 12 and 13 illustrate two perspective exploded views of the assembly of the grip controller 21 rotatable about the second axis A₂. A shaft 62 extends through the upper housing 80, comprising the upper rotatable part 64 mounted upon an intermediate pivot part 65. A first end of the shaft 62 engages with the spring-arms 110b, 120b. The first lateral tab 146b, fixed to the upper rotatable part 64, is configured to move with the second movement R₂ of the grip controller 21, while the second lateral tab 148b is fixed to the intermediate pivot part 65. Each of the lateral tabs 146b, 148b are fitted between the spring-arms 110b, 120b. The other end of the shaft 62 extends through the leaf spring housing 201b to engage with the sensor 34b.

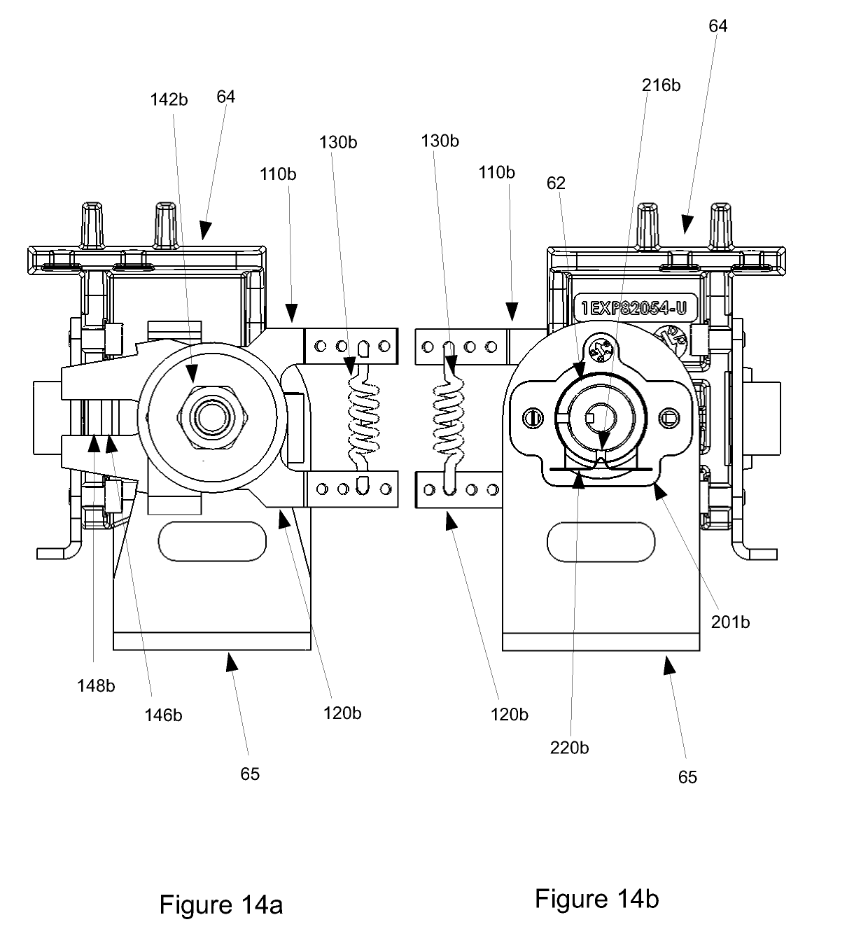

FIGS. 14a and 14b show opposite side views of the assembly of FIGS. 12 and 13 that pivots about the axis A₂, wherein the grip controller 21 is in the neutral position. The first and second lateral tabs 146b, 148b are aligned between the spring arms 110b, 120b.

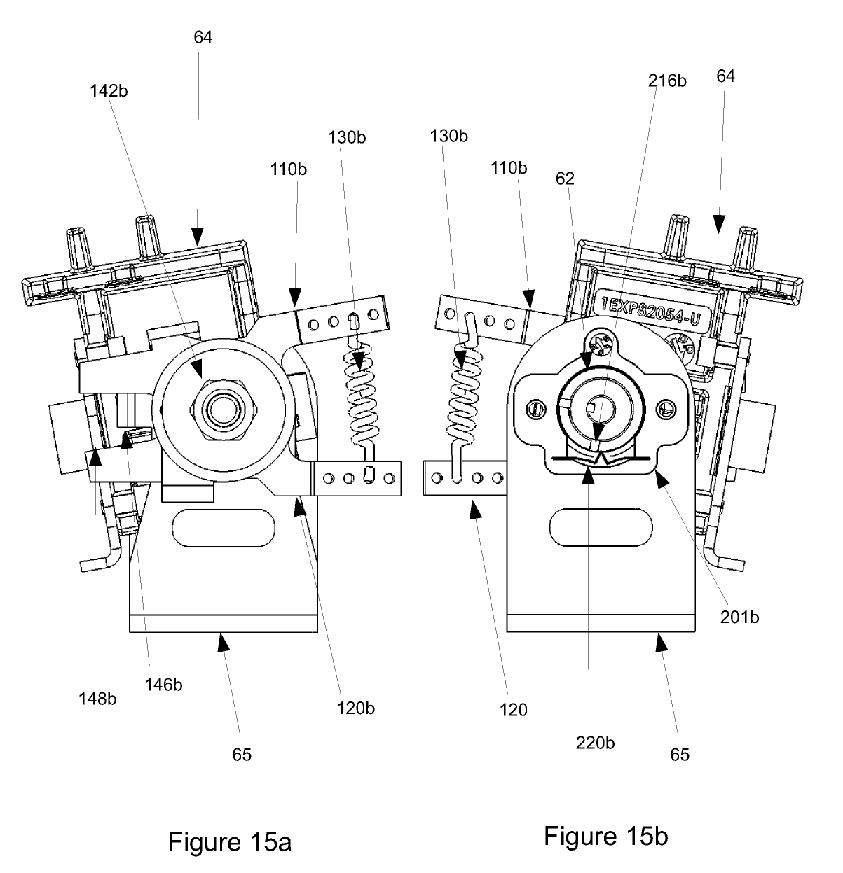

FIGS. 15a and 15b show opposite side views corresponding to FIGS. 14a and 14b, wherein the grip controller 21 is in a biased position. An operative movement R₂ of the grip controller 21 about the axis A₂ causes the lateral tab 148b to force the spring-arm 120b away from the spring-arm 110a that is held in place by lateral tab 146b, increasing the tension in spring 130b and forcing the V-shaped bend of the leaf spring 220b from the cavity 216b. When the operative force is released, the tension in the spring 130b urges the spring-arms 110b and 120b together, bringing the lateral tabs 146b, 148b together and the handle 22 into the neutral position as shown in FIGS. 14a and 14b, whereupon the V-shaped bend of the leaf spring 220b enters the cavity 216b.

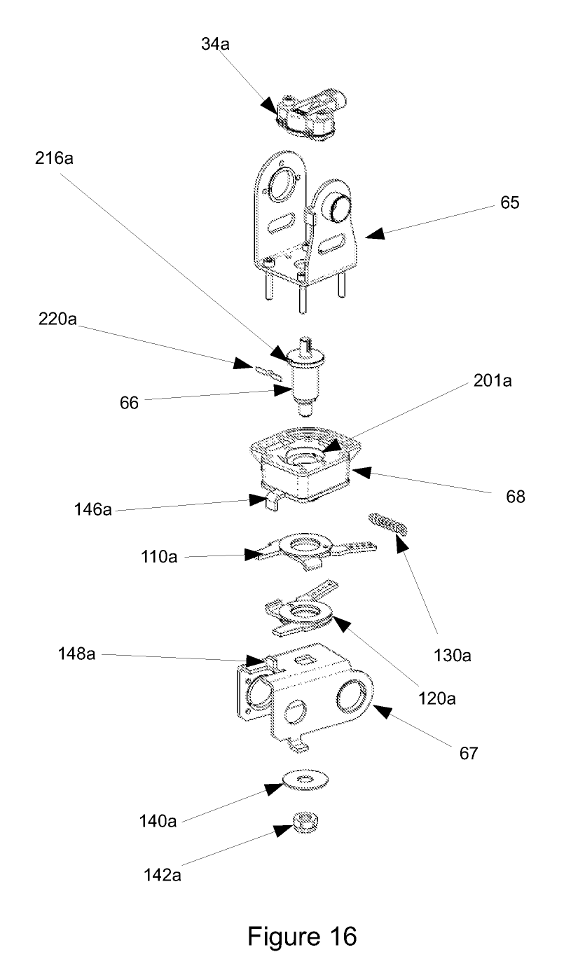

FIG. 16 shows an exploded view of an assembly of the grip controller 21 rotatable about the first axis A₁. The intermediate pivot part 65 is fixedly connected to a base part 68 of the upper housing 80. The base part 68 is rotatably attached to a lateral pivoting part 67, the latter which will be further described later. A shaft 66 with a cavity 216a extends through each of the intermediate pivot part 65, the base part 68, and the lateral pivoting part 67. The top end of the shaft 66 fits with the sensor 34a.

The base part 68 incorporates a leaf spring housing 201a configured to receive a leaf spring 220a. The base part 68 also provides a first lateral tab 146a configured to fit between spring arms 110a, 120a. Spring arms 110a, 120a are provided between the base part 68 and the lateral pivoting part 67.

The lateral pivoting part 67 provides a second lateral tab 148a, also configured to fit between spring arms 110a, 120a. The shaft 66 is secured to the lateral pivoting part 67 with a washer 140a and a nut 142a.

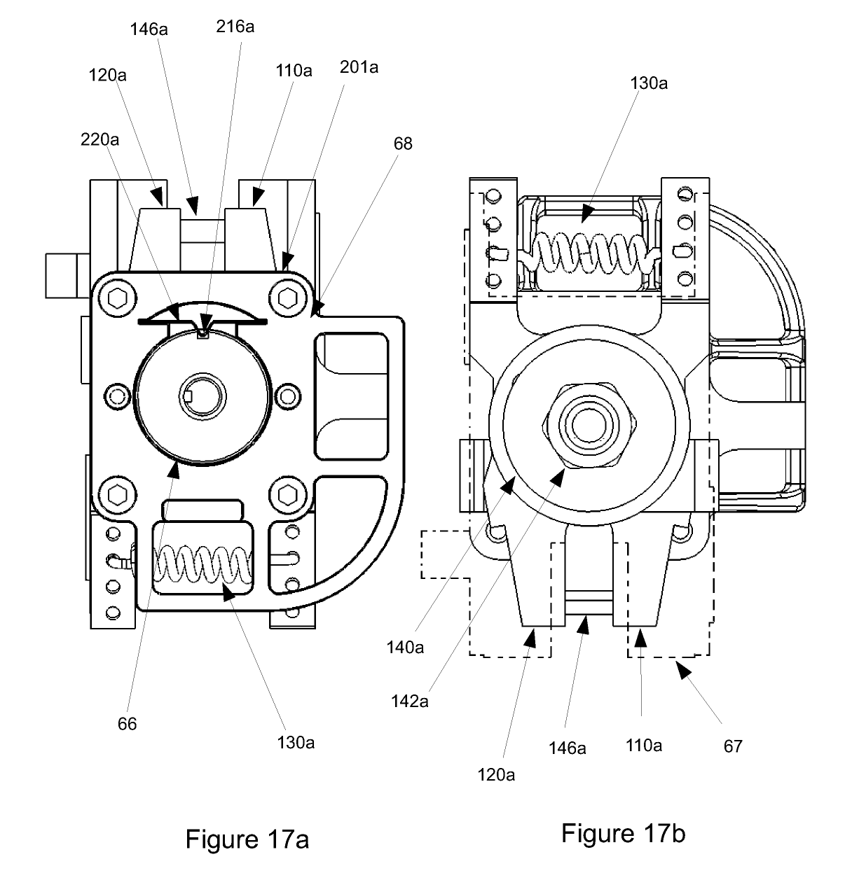

FIGS. 17a and 17b show respective top and bottom views of the assembly of FIG. 16 when in a neutral position. In the top view FIG. 17a the sensor 34a is excluded so that the shaft 66, cavity 216a, and leaf spring 220a are shown. In the bottom view FIG. 17b, the lateral pivoting part 67 is illustrated with dotted lines to better illustrate the spring arms 110a, 120a behind the lateral pivoting part 67.

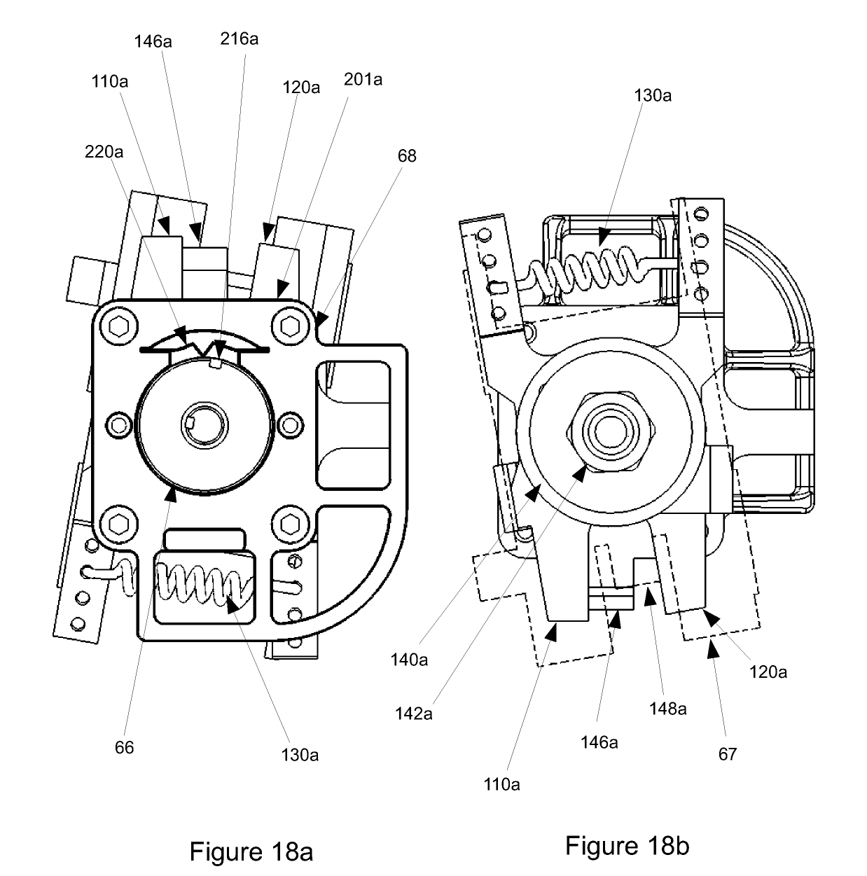

FIGS. 18a and 18b correspond to FIGS. 17a and 17b except that the assembly of FIG. 16 is shown in a biased position. An operative movement R₁ of the grip controller 21 about the axis A₁ causes the lateral tab 148a to force the spring-arm 120a away from the spring-arm 110a that is held in place by lateral tab 146a, increasing the tension in spring 130a and forcing the V-shaped bend of the leaf spring 220a from the cavity 216a. When the operative force is released, the tension in the spring 130a urges the spring-arms 110a and 120a together, bringing the lateral tabs 146a, 148a together and the handle 22 into the neutral position as shown in FIGS. 17a and 17b, whereupon the V-shaped bend of the leaf spring 220a enters the cavity 216a.

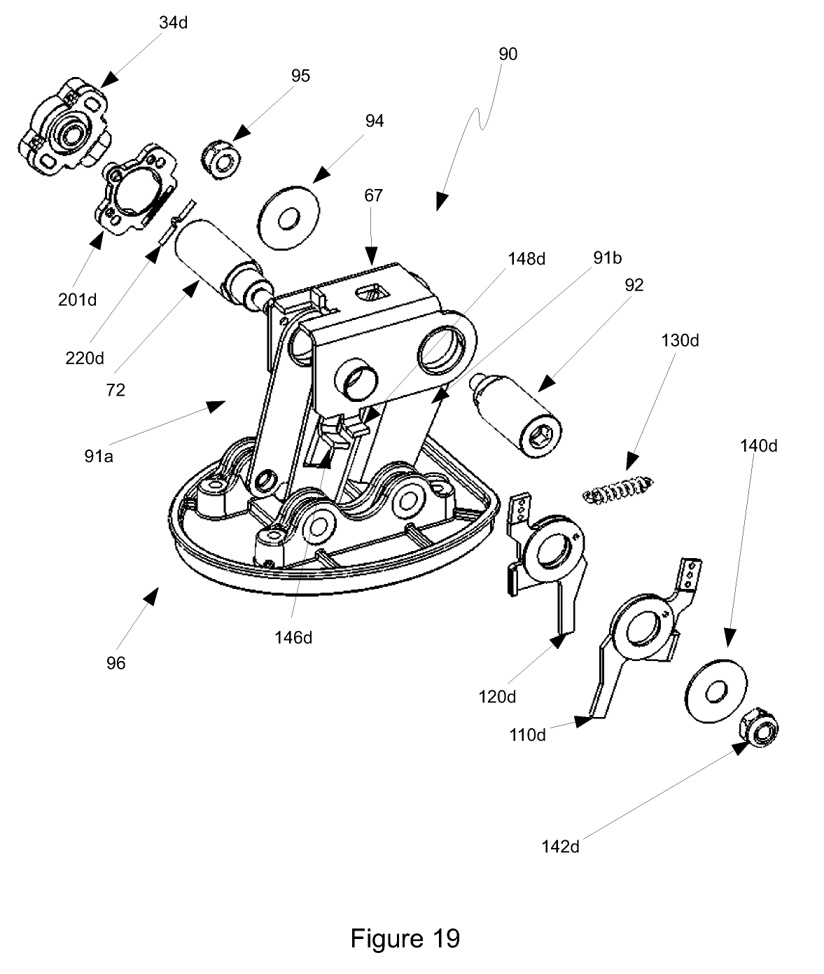

FIG. 19 shows an exploded view of an assembly of the parallelogram mechanism 90. The lateral pivoting part 67 is mounted upon two arms 91a-b, which in turn are each pivotably mounted to positions on a base 96. One of the arms 91a is mounted to the lateral pivoting part 67 by way of a first shaft 72, and the other arm 91b is mounted to the lateral pivoting part by way of a second shaft 91. The second shaft 91 is secured by way of a washer 94 and a nut 95.

The first shaft 72 extends entirely through the lateral pivoting part 67. One end of the first shaft 72 extends through a leaf spring housing 201d to connect with a sensor 34d. The other end of the first shaft 72 extends through spring arms 110d, 120d. The spring arms 110d, 120d are secured by way of a washer 140d and a nut 142d. First lateral tab 146d is provided on the first arm 91a for movement with a movement of the first arm 91a. Second lateral tab 148d is provided on the lateral pivoting part 67.

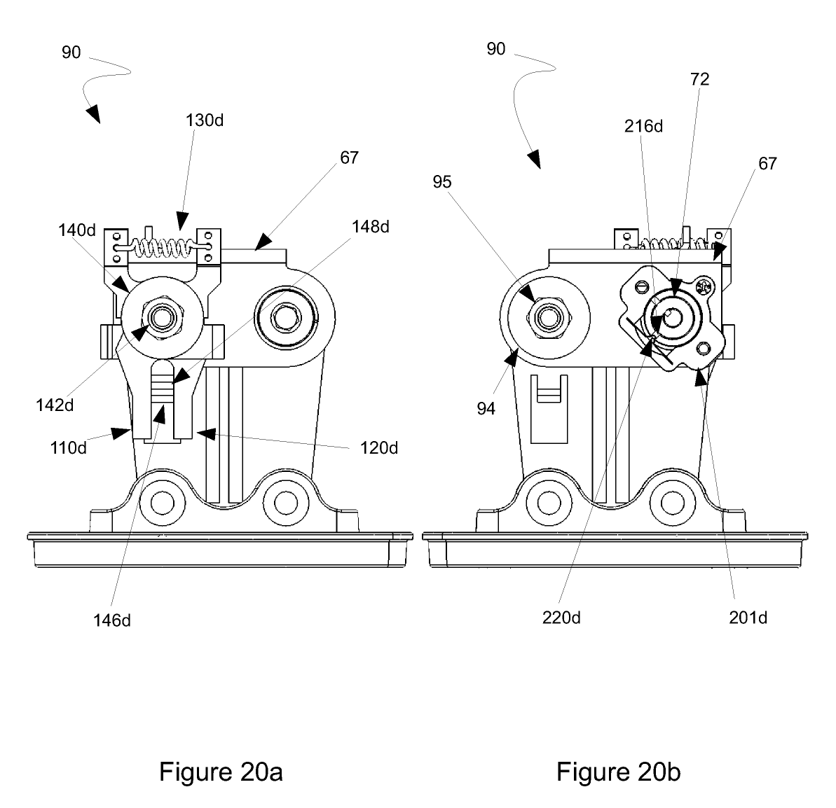

FIGS. 20a and 20b illustrate opposite side views of the parallelogram mechanism 90 of FIG. 19. FIG. 20a faces the spring arms 110d, 120d, and FIG. 14b faces the leaf spring housing 201d. The first shaft 72 includes cavity 216d configured to fit with the V-shaped bend of leaf spring 220d. The spring arms 110d, 120d enclose lateral tabs 146d, 148d. As shown in FIGS. 20a and 20b, the parallelogram mechanism 90 is in the neutral position.

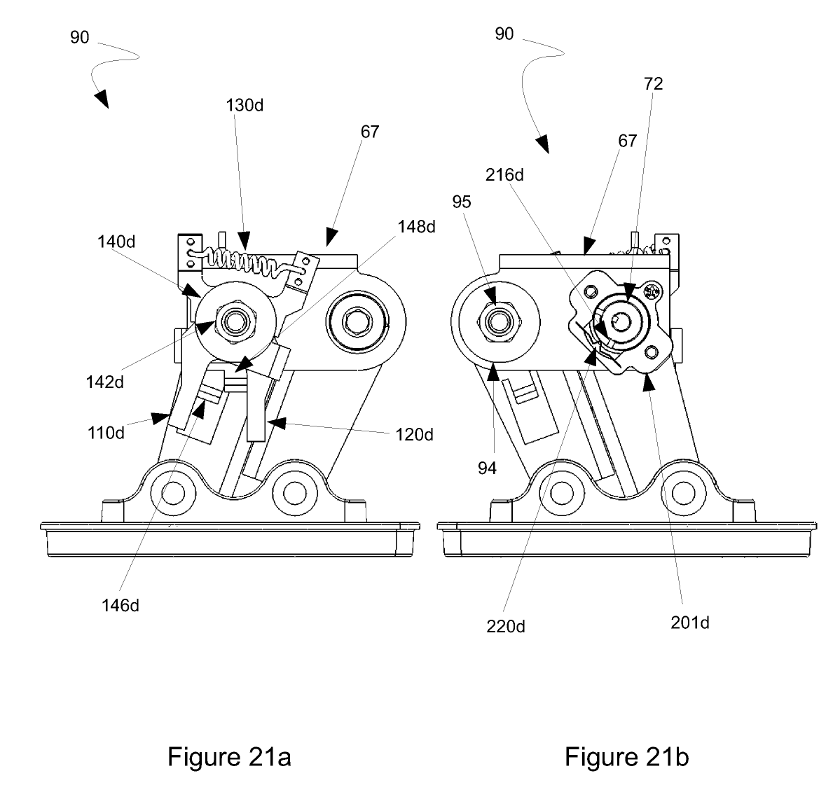

FIGS. 21a and 21b correspond respectively with FIGS. 20a and 20b except that the parallelogram mechanism 90 is in a biased position. The first lateral tab 146d is configured to move with the first arm 91a in accordance with a movement D_{H} of the grip controller 21. With said movement, the lateral tab 146d forces the spring-arm 120d away from the spring-arm 110d, increasing the tension in spring 130d and forcing the V-shaped bend of the leaf spring 220d from the cavity 216d. When the operative force in the horizontal direction D_{H} is released, the tension in the spring 130d urges the spring-arms 110d and 120d together, bringing the handle 22d into the neutral position shown in FIGS. 20a and 20b whereupon the V-shaped bend of the leaf spring 220d enters the cavity 216d.

In the preceding description, for purposes of explanation, numerous details are set forth in order to provide a thorough understanding of the embodiments of the present invention. However, it will be apparent to one skilled in the art that these specific details are not required in order to practice the present invention. The invention as described herein may comprise one, several, all, or any of the embodiments provided above in any combination. The above-described embodiments of the present invention are intended to be examples only. Alterations, modifications and variations can be effected to the particular embodiments by those of skill in the art without departing from the scope of the invention, which is defined solely by the claims appended hereto.

What is claimed is:

1. A self-centering hand-operated control system for remotely controlling a hydraulic machine having at least three movable positioning elements, comprising:
a hand-operated control device (21), including an elongated handle (22) with a coupling portion at one end and a gripping portion extending from the coupling portion along a longitudinal axis (A_{L}), the gripping portion being configured to be gripped by an operator's hand,
the control device (21) also including a control assembly (28) rotatably coupled to the coupling portion of the elongated handle (22) such that the elongated handle (22) is rotatable about the longitudinal axis (A_{L}),
the control assembly (28) configured to be responsive to operative movements of the elongated handle (22) about a first axis (A₁) perpendicular to the longitudinal axis and about a second axis (A₂) perpendicular to the first axis, and comprising a first electronic sensor configured to generate a first signal responsive to a first rotational movement (R₁) about the first axis (A₁), a second electronic sensor configured to generate a second signal responsive to a second rotational movement (R₂) about the second axis (A₂), and a third electronic sensor configured to generate a third signal responsive to a third rotational movement (R₃) of the elongated handle about the longitudinal axis (A_{L}),
the control assembly further comprising centering assemblies for resiliently maintaining the hand operated control device (21) in neutral positions with respect to said first, second, and third axes (A_{L}, A₁, A₂) in the absence of an operative force applied to the elongated handle (22);
a control interface (54) configured to receive the generated signals from the control device and pilot a hydraulic valve device configured to operate hydraulic motors for positioning the movable positioning elements; and
a transmission interface (50) for transmitting the generated signals from the control device to the control interface.

2. The control system according to claim 1, wherein the first, second, and third electronic sensors are potentiometers operable in response to the first, second, and third movements (R₁, R₂, R₃), respectively.

3. The control system according to claim 1, wherein one of more of the first, second, and third electronic sensors are Hall effect sensors configured to measure relative angular displacement.

4. The control system according to claim 1,
wherein the elongated handle (22) comprises a trigger lever (24) extending along the longitudinal length of the elongated handle (22) and configured to rotate about the longitudinal axis (A_{L}) with the rotation of the elongated handle (22), the trigger lever (24) configured to generate a trigger signal responsive to an operative squeezing of the trigger lever (24) by the operator's hand.

5. The control system according to claim 1, wherein the control assembly further comprises a parallelogram mechanism (90) pivotally movable by a horizontal displacement (D_{H}) along a horizontal direction (H) of the elongated handle (22), the parallelogram mechanism (90) including a fourth electronic sensor configured to generate a signal responsive to the horizontal displacement.

6. The control system according to claim 4, wherein the control interface (54) is further configured to override the first, second, and third signals received respectively from the first, second, and third electronic sensors upon receiving the trigger signal.

7. The control system according to claim 1, wherein each of the centering mechanisms are configured to limit an angular displacement to a maximum angular displacement.

8. The control system according to claim 7, wherein each centering mechanism comprises:
first and second commonly pivoted spring arms (110, 120) each having a middle portion, a distal end (112, 122), a proximal end opposite the distal end (110, 120), and a lateral extension (116, 126), each of the proximal end, the distal end, and the lateral extension extending from the middle portion,
the first and second spring arms (110, 120) configured to rotate with respect to each other about a common axis through the respective middle portions,
the middle portions of the spring arms having openings for receiving a pivot shaft,
the distal ends (112, 122) of the spring arms being connected to each other by a tension device (130) configured to urge the distal ends toward each other, and
the lateral extensions (116, 126) of the spring arms having stop portions configured to limit a rotational motion of said spring arms about the common axis to the maximum angular displacement.

9. The control system according to claim 8, wherein the stop portions of each spring arm is configured to abut against a corresponding abutment portion of the opposite spring arm.

10. The control system according to claim 8, wherein each centering mechanism further comprises:
a shaft configured to rotate with at least one of the operative movements of the elongated handle (22) and further configured to engage with one of the first, second, or third electronic sensors, an outer peripheral surface around a circumference of the shaft having a cavity (216) extending into the surface of the shaft, and
a leaf spring (220) with first and second ends and an engagement portion between the first and second ends, the leaf spring configured to urge the engagement portion against the outer peripheral surface of the centering disk,
the cavity (216) and the engagement portion configured such that the engagement portion may reversibly enter the cavity (216) and act against a torque applied to the shaft about an axis through the shaft to prevent a rotation of the shaft about the axis where the torque is less than a predetermined value greater than zero.

11. A self-centering hand-operated control device for remotely controlling a hydraulic machine having at least three movable positioning elements, comprising:
an elongated handle (22) with a coupling portion at one end and a gripping portion extending from the coupling portion along a longitudinal axis (A_{L}), the gripping portion being configured to be gripped by an operator's hand;
a control assembly (28) with a first end rotatably coupled to the coupling portion of the elongated handle such that the elongated handle (22) is rotatable about the longitudinal axis (A_{L}),
the control assembly (28) extending along a first axis (A₁) perpendicular to the longitudinal axis (A_{L}) from the first end to a second end configured to be mounted to a surface,
the control assembly (28) including a plurality of sensors each configured to generate signals responsive to an operative movement of the elongated handle (22) about any of the longitudinal axis (A_{L}), the first axis (A₁), and a second axis (A₂) orthogonal to the longitudinal and first axes (A_{L}, A₁), and
the control assembly (28) also including centering mechanisms configured to resiliently maintain the elongated handle (22) and the control assembly (28) in a neutral position respective to the longitudinal axis (A_{L}), the first axis (A₁), and the second axis (A₂) in the absence of an operative force upon the elongated handle (22).

12. The control device according to claim 11, wherein at least one of the sensors is a potentiometer, comprising a housing and an actuating shaft, the potentiometer configured to vary an electrical signal responsive to a relative angular displacement of the actuating shaft relative to the housing.

13. The control device according to claim 11, wherein at least one of the sensors is a Hall effect sensor, comprising a housing and an actuating shaft, the Hall effect sensor configured to vary signal responsive to a relative angular displacement of the actuating shaft relative to the housing.

14. The control device according to claim 11, further comprising:
a trigger lever (24) extending along the longitudinal length of the elongated handle (22) and configured to rotate about the longitudinal axis (A_{L}) with the rotation of the elongated handle (22), the trigger lever (24) configured to generate a trigger signal responsive to an operative squeezing of the trigger lever (24) by the operator's hand.

15. The control device according to claim 11, wherein the control assembly further comprises:
a parallelogram mechanism (90) comprising a horizontal body and arms pivotably mounted on opposite ends of the horizontal body, each of the arms configured to be pivotably mounted to respective mount points on a base to enable a horizontal movement of the horizontal body in a horizontal direction (H) orthogonal to the first axis (A₁),
the parallelogram mechanism (90) including a displacement sensor configured to generate a signal responsive to a horizontal displacement (D_{H}) of the horizontal body in the horizontal direction (H),
the parallelogram mechanism (90) also including a return mechanism configured to resiliently maintain the parallelogram mechanism (90) in a predetermined position in the absence of an operative horizontal force upon the elongated handle (22) along the horizontal direction (H).

16. The control device according to claim 15,
wherein the elongated handle (22) is coupled to a first section (80) of the control assembly (28), the first second including the plurality of sensors and the centering mechanisms,
wherein the first section (80) is pivotably mounted to a second section of the control assembly, the second section including the parallelogram mechanism (90), the first section configured to pivot about the first axis relative to the second section, a first of the plurality of sensors being configured to indicate an operative force to pivot the first section about the second section,
wherein the elongated handle (22) comprises a first pivot shaft extending along the longitudinal axis (A_{L}), the first pivot shaft configured to rotate with a first operative motion about the longitudinal axis (A_{L}) and further configured to engage with a second of the plurality of sensors located at an end of the first pivot shaft, an outer peripheral surface around a circumference of the first pivot shaft at an end of the first pivot shaft having a first cavity extending into the surface of the first pivot shaft, the end of the first pivot shaft extending through an opening in a first leaf spring housing, the first leaf spring housing including a first leaf spring having an first engagement portion in engagement with the outer peripheral surface of the first pivot shaft and configured to reversibly enter the first cavity of the first pivot shaft to prevent a rotation of the first pivot shaft about the longitudinal axis (A_{L}) where a torque applied to the first pivot shaft is less than a first predetermined value greater than zero, and
wherein one of the arms of the parallelogram mechanism is connected to a second pivot shaft configured to rotate responsive to a horizontal displacement (D_{H}) of the horizontal body, the second pivot shaft configured to engage with the displacement sensor, an outer peripheral surface around a circumference of the second pivot shaft at an end of the second pivot shaft having a cavity extending into the surface of the second pivot shaft, the end of the second pivot shaft extending through an opening in a second leaf spring housing, the second leaf spring housing including a second leaf spring having a second engagement portion in engagement with the outer peripheral surface of the second pivot shaft and configured to reversibly enter the second cavity of the first pivot shaft to prevent a rotation of the second pivot shaft about an axis through a center of the second pivot shaft where a torque applied about axis through a center of the second pivot shaft is less than a predetermined value greater than zero.

17. The control device according to claim 11, wherein each of the centering mechanisms configured to limit an angular displacement to a maximum angular displacement.

18. The control system according to claim 17, wherein each centering mechanism comprises:
first and second commonly pivoted spring arms (110, 120) proximate to each other and configured to rotate with respect to each other about a common axis, each of the spring arms having a middle portion, a distal end (112, 122), a proximal end opposite the distal end (110, 120), and a lateral extension (116, 126), each of the proximal end, the distal end, and the lateral extension extending from the middle portion,
the first and second spring arms (110, 120) configured to rotate with respect to each other about a common axis through the respective middle portions,
the middle portions of the spring arms having openings for receiving a pivot shaft,
the distal ends (112, 122) of the spring arms being connected to each other by a tension device (130) configured to urge the distal ends toward each other, and
the lateral extensions (116, 126) of the spring arms having stop portions configured to limit a rotational motion of said spring arms about the common axis to the maximum angular displacement.

19. The control system according to claim 18, wherein the stop portions of each spring arm is configured to abut against a corresponding abutment portion of the opposite spring arm.

20. The control system according to claim 18, wherein each centering mechanism further comprises:
a shaft (210) configured to rotate with at least one of the operative movements of the elongated handle (22) and further configured to engage with one of the first, second, or third electronic sensors, an outer peripheral surface around a circumference of the shaft (210) having a cavity (216) extending into the surface of the shaft, and
a leaf spring (220) with first and second ends and an engagement portion between the first and second ends, the leaf spring configured to urge the engagement portion against the outer peripheral surface of the centering disk,
the cavity (216) and the engagement portion configured such that the engagement portion may reversibly enter the cavity (216) and act against a torque applied to the centering disk (210) about an axis through the shaft (120) to prevent a rotation of the shaft (210) about the axis where the torque is less than a predetermined value greater than zero.
